(19) United States
(12) Patent Application Publication
(10) Pub. No.: US 2004/0249067 A1
(43) Pub. Date: Dec. 9, 2004

(54) Novel polymer compositions

(76) Inventors: Martin Edward Fox, Histon (GB); Robert Bruce Appell, Midland, MI (US); Alexander Allan Cantrill, Nr. Royston (GB)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/859,385

(22) Filed: Jun. 2, 2004

Related U.S. Application Data
(63) Continuation-in-part of application No. 10/455,524, filed on Jun. 5, 2003.

(51) Int. Cl. C08G 83/00

(52) U.S. Cl. 525/56; 525/326.1; 525/326.7; 525/326.8; 525/383; 525/403

(57) ABSTRACT

The invention comprises a linear or branched polymer derivative comprising a water soluble and non-peptidic polymer backbone that incorporates an optionally protected vicinal diol, which is either embedded in the polymer backbone or is attached as a pendant group, wherein each linking group (linker) between the polymer backbone and the vicinal diol is a chain comprising at least two adjacent saturated carbon atoms. The invention further comprises a method of using said polymer derivative to form an aldehyde and either a second aldehyde or a ketone by way of oxidative cleavage.

This patent application is a continuation-in-part of U.S. patent application Ser. No. 10/455,524, filed Jun. 5, 2003.

### FIELD OF THE INVENTION

The invention relates to novel mPEG polymer derivatives and, more particularly, to a method of using said derivatives to form an aldehyde and either a second aldehyde or a ketone.

### BACKGROUND OF THE INVENTION

Covalent attachment of the hydrophilic polymer poly(ethylene glycol), abbreviated PEG, also known as poly(ethylene oxide), abbreviated PEO, to molecules and surfaces is of considerable utility in biotechnology and medicine. In its most common form, PEG is a linear polymer terminated at each end with hydroxyl groups:

HO—CH₂CH₂O—(CH₂CH₂O)ₙ—CH₂CH₂OH

The above polymer, alpha-,omega-dihydroxypoly(ethylene glycol), can be represented in brief form HO-PEG-OH where it is understood that the -PEG- symbol represents the following structural unit:

—CH₂CH₂O—(CH₂CH₂O)ₙ—CH₂CH₂—

where n typically ranges from approximately 3 to 4000.

A commonly used form of PEG is methoxy-PEG-OH, or mPEG alcohol in brief, in which one terminus is the relatively inert methoxy group, while the other terminus is a hydroxyl group that is subject to ready chemical modification. The structure of mPEG alcohol is given below. mPEG alcohol can be prepared by reaction of ethylene oxide with methanol.

CH₃O—CH₂CH₂O—(CH₂CH₂O)ₙ—CH₂CH₂—OH

Branched PEGs are also commonly used. The branched forms can be prepared by reaction of ethylene oxide with various compounds having multiple hydroxyl groups, including glycerol, pentaerythritol and sorbitol. For example, the four-armed branched PEG prepared from pentaerythritol is shown below:

Q(CH₂—OH)₄+4n C₂H₄O→Q[CH₂—O—(CH₂CH₂O)ₙ—H]₄

Branched PEGs can be represented as Q(-PEG-OH)ₙ in which Q represents a central core molecule such as pentaerythritol, glycerol or sorbitol, and n represents the number of arms which can range from three to a hundred or more. The hydroxyl groups are readily subject to chemical modification.

Random or block copolymers of ethylene oxide and propylene oxide, shown below are closely related to PEG in their chemistry, and they can be substituted for PEG in many of its applications,

HO—CH₂CHRO—(CH₂CHRO)ₙ—nCH₂CHR—OH

wherein each R is independently H or CH₃.

PEG is a polymer having the properties of solubility in water and in many organic solvents, lack of toxicity, and lack of immunogenicity. For example, see review articles by Kodera et al, (Prog. Polym. Sci, 1998, 23, 1233-1271), Veronese (Biomaterials, 2001, 22, 405-417), Chapman (Advanced Drug Delivery Reviews, 2002, 54, 531-545 and Harris, Martin and Modi (Clinical Pharmacokinetics, 2001, 40, 539-551). To couple PEG to a molecule such as a protein or small drug molecule, it is necessary to use an “activated derivative” of the PEG, having a functional group at the terminus suitable for reaction with a group on the other molecule. A PEG having a terminal aldehyde or aldehyde hydrate group can be covalently linked to a molecule or surface bearing one or more amine groups using the method of reductive amination.

Bentley and Harris (U.S. Pat. No. 5,990,237) disclose the preparation of PEG aldehydes by acid-catalysed hydrolysis of PEG acetals. This method has the disadvantage that the aldehyde product may not be stable under the conditions of the reaction. For example, under acid catalysis, mPEG propionaldehyde may undergo retro-Michael reaction to mPEG alcohol and acrolein. Therefore, there is a need for improved methods of preparation of PEG aldehydes, especially mPEG propionaldehyde, preferably where the final step is carried out under neutral pH conditions.

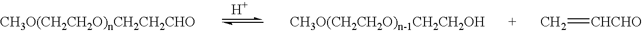

Acetaldehyde-terminated PEG derivatives have also been reported, but the utility of these compounds for biomedical applications is limited by stability and reactivity issues. For example, Royer first described the synthesis of mPEG acetaldehyde and its use in attaching PEG to enzymes (U.S. Pat. No. 4,002,531, 1977), but subsequently several other authors have pointed out its limitations. Paley and Harris (J. Polym. Sci. Polym. Chem. Edn., 1987, 25, 2447-2454) found that an oligomeric version of mPEG acetaldehyde was unstable in the presence of base and of limited utility for biomolecule conjugation in aqueous media. See also a review by Zalipsky (Bioconjugate Chem., 1995, 6, 150-165). Oligomeric aldol condensation products were also observed in the mPEG acetaldehyde prepared by Ladd and Henrichs (Synth. Commun., 1998, 28(22),4143-4149). In addition, PEG acetaldehyde has proven difficult to prepare reproducibly and in high purity. U.S. Pat. No. 5,252,714 to Harris et al. discloses the difficulty in reproducing the methods described by Royer in U.S. Pat. No. 4,002,531. Similarly, Chamow (Bioconjugate Chem., 1994, 5, 133-140) found it difficult to produce mPEG acetaldehyde of good quality, with the aldehyde purity of only 52%.

### SUMMARY OF THE INVENTION

The invention comprises a linear or branched polymer derivative comprising a water soluble and non-peptidic polymer backbone that incorporates an optionally protected vicinal diol, which is either embedded in the polymer backbone or is attached as a pendant group, wherein each linking group (linker) between the polymer backbone and the vicinal diol is a chain comprising at least two adjacent saturated carbon atoms. The invention further comprises a method of using said polymer derivative to form an aldehyde and either a second aldehyde or a ketone by way of oxidative cleavage.

### DETAILED DESCRIPTION OF THE PREFERRED EMBODIMENTS

According to the invention, a linear or branched polymer derivative is provided, comprising a water soluble and non-peptidic polymer backbone that incorporates an optionally protected vicinal diol, which is either embedded in the polymer backbone or is attached as a pendant group, wherein each linking group (linker) between the polymer backbone and the vicinal diol is a chain comprising at least two adjacent saturated carbon atoms. The polymer derivative of the invention has a partial structure according to formula (1):

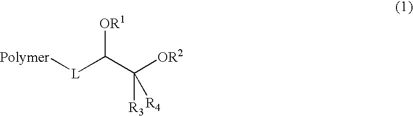

wherein R¹ and R² are independently H or a hydroxyl-protecting group or may be linked together to form a cyclic diol-protecting group. R³ and R⁴ are independently H or a hydrocarbon group or a second polymeric chain or may be linked to form a cyclic hydrocarbon. L represents a linker molecule between the polymer backbone and the vicinal diol moiety. Polymer is a linear or branched polymer or a block or random copolymer.

When the vicinal diol in (1) is protected, it is preferable that the protecting group (or groups) is base stable. More preferably, R¹ and R² are linked to form a cyclic ketal or cyclic acetal. Yet more preferably, R¹ and R² in the cyclic ketal or acetal together comprise a dialkylmethylene or alkylmethylene group, which may be selected from the group consisting of isopropylidene, diethylmethylene, cyclohexylidene, cyclopentylidene and benzylidene. The preferred hydrocarbon which may comprise R³ or R⁴ is selected from the group consisting of methyl, ethyl, and propyl and additionally the group CR³R⁴ may comprise cyclic hydrocarbons such as cyclopentyl or cyclohexyl. More preferably, R³ and R⁴ are both hydrogen.

The polymer derivative of formula (1) may be more particularly characterized according to the following formula (2):

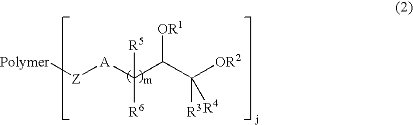

wherein:

(i) Polymer is selected from the group consisting of poly(ethylene glycol), oligo(ethylene glycol), poly(vinyl alcohol), poly(alkylene oxides), poly(oxyethylated polyols), poly(olefinic alcohols), poly(acryloyl morpholine), poly(vinyl pyrrolidine), poly(oxazoline), dextran, poly(hydroxyethyl methacrylate) and derivatives thereof. Preferably, Polymer is selected from the group consisting of poly(ethylene glycol) or oligo(ethylene glycol), wherein the oligo(ethylene glycol) group is selected from the group consisting of (CH₂CH₂O)ₙ, wherein n is about 1-10. More preferably Polymer is poly(ethylene glycol) and derivatives thereof and most preferably Polymer is methoxy poly(ethylene glycol), i.e. MeO(CH₂CH₂O)ₙ.

(ii) Z is a hydrolysable or non-hydrolysable linker and is preferably a linear or branched non-hydrolysable hydrocarbon optionally containing one or more heteroatoms. More preferably Z is —CH₂CH₂.

(iii) A represents O, S, SO, SO₂, N, or NR⁷ wherein R⁷ is H, a hydrocarbon, a protecting group or a capping group. A is preferably O.

(iv) R⁵ and R⁶ are independently H or alkyl and on different C atoms within the group (CR⁵R⁶)ₙ may either be the same or different. Preferably R₅ and R₆ are both H.

(v) m is at least 2 and preferably has a value equal to 2.

(vi) j is in the range 1 to 4 and preferably has a value equal to 1.

Specific preferred embodiments of formula (2) are provided in the following Table:

| | Polymer | Z | A | m | j | R¹ and R² | R³ and R⁴ | R⁵ and R⁶ |
|---|---|---|---|---|---|---|---|---|
| 1 | MeO-(CH₂CH₂O)₂ | (CH₂)₂ | O | 2 | 1 | Both H | Both H | Both H |
| 2 | MeO-(CH₂CH₂O)₂ | (CH₂)₂ | O | 2 | 1 | isopropylidene | Both H | Both H |
| 3 | HO-(CH₂CH₂O)ₙ | (CH₂)₂ | O | 2 | 1 | isopropylidene | Both H | Both H |
| 4 | MeO-(CH₂CH₂O)ₙ | (CH₂)₂ | O | 2 | 1 | isopropylidene | Both H | Both H |
| 5 | MeO-(CH₂CH₂O)ₙ | (CH₂)₂ | O | 2 | 1 | Both H | Both H | Both H |

In particularly preferred specific embodiments, the composition of formula (2) corresponds to table entries 4 and 5 and is characterized by low polydispersity and a high molecular weight. In such a composition, low polydispersity means polydispersity of less than 1.1 and high molecular weight means a defined molecular weight of at least 5000 (5K) and up to about 60K, chosen to suit the particular biomedical application for which the composition is required. Defined molecular weights may be selected from the list comprising 5K, 10K, 20K, 30K and 40K. Commonly although not exclusively, the defined molecular weight is 20K or 30K.

The invention further comprises a method of forming an aldehyde and either a second aldehyde or a ketone by oxidative cleavage of a polymer derivative according to formula (1) or formula (2). In preferred embodiments, the vicinal diol is protected and such a method also comprises the prior step of deprotection.

Although a wide range of oxidants may effect the oxidative cleavage process, it is beneficial to use an oxidant that does not result in contamination of the product with toxic residues, for example lead- or chromium-containing residues. Accordingly, it is preferable that the oxidative cleavage is effected by treatment of the polymer derivative with a hypervalent iodine reagent selected from the group consisting of 2-iodoxybenzoic acid and the Dess-Martin periodinane (1,1,1-triacetoxy-1,1-dihydro-1,2-benziodoxol-3(1H)-one) or a periodate reagent selected from the group consisting of periodic acid, lithium periodate, sodium periodate, potassium periodate, quaternary ammonium periodates such as tetrabutylammonium periodate, and polymer supported periodates such as (polystyrylmethyl)trimethylammonium periodate. The inexpensive oxidant sodium periodate is suitable in most cases. In embodiments including the prior step of deprotection, it is preferable that the vicinal diol is protected as a cyclic ketal or cyclic acetal and for such deprotection to be carried out in an aqueous medium. More preferably, the deprotection step comprises acid-catalysed hydrolysis. Optionally, in cases where the cyclic acetal is benzylidene or an analogue thereof, the deprotection step comprises hydrogenolysis.

It may be particularly advantageous to combine the steps of deprotection and oxidative cleavage in a single vessel operation. For example, this is facilitated when both steps are effected in an aqueous medium and the method comprises (a) deprotection of a cyclic acetal or ketal by acid-catalysed hydrolysis, (b) adjustment of the pH of the reaction medium by addition of base, typically an aqueous base, to a pH in the range of about 4-7 and (c) addition of sodium periodate, or other oxidant as described above.

The invention is further illustrated by the following examples.

### EXAMPLE 1

### 4-{2-[2-(2-Methoxy-ethoxy)-ethoxy]-ethyl}-2,2-dimethyl-[1,3]dioxolane

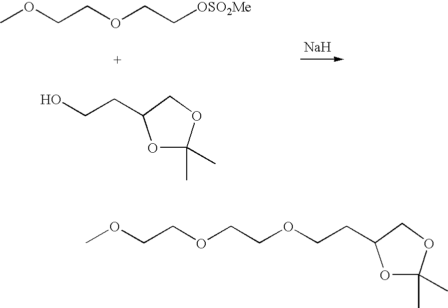

Sodium hydride (60% in oil, 1.57 g, 39.2 mmol) was suspended in anhydrous THF (20 mL) under nitrogen. A solution of 2-(2,2-Dimethyl-[1,3]dioxolan-4-yl)-ethanol in THF(25 mL) was added over 45 minutes. The suspension was stirred for 30 minutes, then 2-(2-Methoxy-ethoxy)-ethyl mesylate (6.47 g, 32.6 mmol) was added. The suspension was heated to reflux for 2 h, then allowed to cool. Saturated sodium bicarbonate solution (50 mL) and dichloromethane (50 mL) were added. The mixture was shaken, the organic layer was removed and the aqueous layer was extracted with dichloromethane (2×25 mL). The solution was dried (MgSO₄), filtered and the solvent was evaporated. THF (20 mL), triethylamine (454 mL, 32.6 mmol) and succinic anhydride (3.26 g, 32.6 mmol) were added. The solution was stirred for 1 h, quenched with saturated sodium bicarbonate solution (50 mL), then dichloromethane (50 mL) was added. The mixture was stirred for 30 minutes, then the organic layer was separated. The aqueous layer was extracted with dichloromethane (2×25 mL). The solution was dried (MgSO₄), filtered and the solvent was evaporated. The product was purified by flash chromatography on silica, eluting with heptane-ethyl acetate (1:1) to give the title compound as a mobile, colourless liquid (3.3 g, 41%); ¹H NMR (400 MHz, C₆DCl₃) δ 4.19 (1H, quintet, J=6.6 Hz), 4.06 (1H, dd, J=8.0, 6.0 Hz, 3.66-3.51 (11H,m), 3.38 (3H, s), 1.94-1.19 (2H, m), 1.40 (3H, m) and 13.5 (3H, m); ¹³C NMR (100 MHz, C₆DCl₃) δ108.5, 73.9, 72.0, 70.62, 70.58, 70.3, 69.6, 68.0, 33.8, 26.9 and 25.8.

### EXAMPLE 2

### 3-[2-(2-Methoxy-ethoxy)-ethoxy]-propionaldehyde

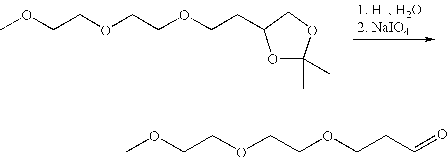

4-{2-[2-(2-Methoxy-ethoxy)-ethoxy]-ethyl}-2,2-dimethyl-[1,3]dioxolane (502 mg, 2.02 mmol) was dissolved in water (2 mL) and ˜2 molar sulfuric acid (2 drops) was added. The solution was stirred at room temperature for 90 minutes, then neutralised to pH 5-6 with saturated sodium bicarbonate solution. Sodium periodate (476 mg, 2.22 mmol) was added. Water (a few mL) was added to dissolve the white precipitate, then the solution was extracted with dichloromethane (6×2.5 mL). The combined organic layers were dried (MgSO₄), filtered and the solvent was evaporated to give 3-[2-(2-methoxy-ethoxy)-ethoxy]-propionaldehyde as a colorless, mobile oil (348 mg, 97%); ¹H NMR (400 MHz, C₆D₆) δ 9.47 (1H, t, J=1.8 Hz), 3.53-3.46 (6H, m), 3.43-3.40 (4H, m), 3.22 (3H, s) and 2.18 (2H, td, J=6.0, 1.8 Hz); ¹³C NMR (100 MHz, C₆D₆) δ 200.2, 72.7, 71.2, 71.2, 71.1, 67.2, 0.59 and 44.3).

### EXAMPLE 3

### Naphthalene-2-sulfonic acid 2-(2,2-dimethyl-[1,3]dioxolan-4-yl)-ethyl ester

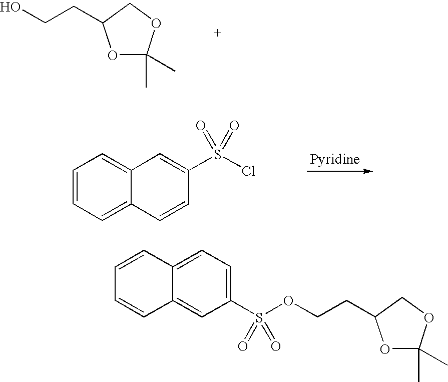

A solution of 2-(2,2-Dimethyl-[1,3]dioxolan-4-yl)-ethanol (10.0 g, 68.4 mmol) in pyridine (40 mL) was cooled to 0-10° C. 2-Naphthalenesulfonyl chloride (18.6 g, 82.08 mmol) was added and the solution was stirred at 0-10° C. for 1.5 h, when additional 2-naphthalenesulfonyl chloride (18.6 g, 82.08 mmol) was added. The suspension was stirred for another 30 minutes, then the reaction was quenched with water (5 mL) and the solution was stirred for 30 minutes. Toluene (50 mL) and 5% citric acid (50 mL) were added, then the mixture was titrated to pH 3 with 2M hydrochloric acid (about 150 mL). The aqueous layer was removed, then the organic layer was washed with 5% citric acid (50 mL) and saturated sodium bicarbonate solution (50 mL), dried (MgSO₄), filtered and the solvent was evaporated. The compound was recrystallized from methanol-triethylamine (99:1) to give a white, granular solid (14.7 g, 64.0%). The compound was recrystallized again from toluene-heptane-triethylamine (49.5:50:0.5) to give the title compound as a white granular solid (7.90 g, 34.3%); ¹H NMR (400 MHz, CDCl₃) δ 8.50 (1H, δ, J=1.6 Hz), 8.01 (1H, d, J=8.4 Hz), 8.00 (1H, d, J=7.6 Hz), 7.94 (1H, d, J=8.0 Hz) 7.86 (1H, dd, J=9.2, 2.0 Hz), 7.72-7.69 (1H, m), 7.67-7.63 (1H, m) 4.25-4.16 (2H, m), 4.15-4.08 (1H, m), 4.01 (1H, dd, J=8.0, 6.4 Hz), 1.95-1.84(2H, m), 1.29 (3H, s) and 1.23 (3H, s); ¹³C NMR (100 MHz, CDCl₃) δ 135.3, 132.7, 132.0, 129.8, 129.7, 129.4, 129.3, 128.0, 127.9, 122.5, 109.1, 72.2, 69.1, 67.7, 33.2, 26.8 and 25.4.

### EXAMPLE 4

### 5K mPEG C4 acetonide

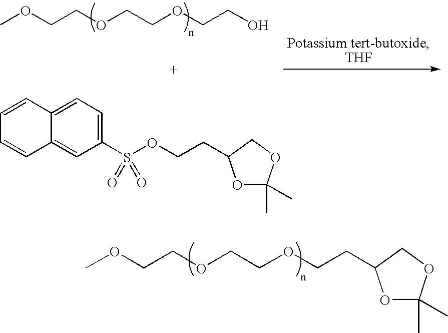

mPEG Alcohol (Mwt 5,000, 20.0 g, ˜4 mmol) was placed in a dry flask. This was purged with nitrogen, then anhydrous THF (40 mL) and potassium tert-butoxide (1.0 M in THF, 20 mL) were added. The suspension was heated to 45° C. A solution of 2-(2,2-dimethyl-[1,3]dioxolan-4-yl)-ethyl-2-naphthalenesulfonate (6.7 g, 20 mmol) in anhydrous THF (20 mL) was added over 1 h. The suspension was stirred at 40° C. for 1 h, then allowed to cool. Most of the solvent was evaporated then the residue was taken up in hot toluene (100 mL), filtered, and the filter cake was washed through with hot toluene (4×25 mL). The solvent was evaporated from the filtrate, then the solid residue was dissolved in hot toluene (100 mL). Heptane (100 mL) was added, the suspension was stirred for 16 h, then filtered and the solid was dried under vacuum to give mPEG C4 acetonide as a white granular solid (17.9 g, 89%). ¹H NMR analysis indicated mPEG C4 acetonide to be present at about 85-90% of the total mPEG. ¹H NMR (400 MHz, CDCl₃) δ 4.19 (1H, quintet, J=6.5 Hz), 4.06 (1H, dd, J=8.0, 5.6 Hz), 3.38 (3H, s), 3.89-3.86 (2H, m), 3.48-3.45 (2H, m), 1.92-1.80 (2H, m), 1.40 (3H, s) and 1.35 (3H, s); ¹³C NMR (100 MHz, CDCl₃) δ 108.4, 73.8, 72.5, 69.6, 67.9, 59.0, 33.7, 26.9 and 25.8.

### EXAMPLE 5

### 5K mPEG C4 diol

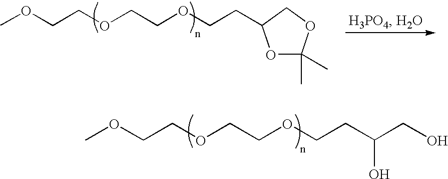

5K MPEG C4 acetonide (7.0 g, ˜1.4 mmol) was dissolved in water (100 mL). A solution of orthophosphoric acid (137 mg, 1.40 mmol) in water (1 mL) was added. The solution was stirred at room temperature for 4 h, then neutralized to pH 7 with 2M sodium hydroxide. Most of the solvent was evaporated, then dichloromethane (100 mL) was added, followed by magnesium sulfate. The suspension was filtered and the solvent was evaporated to give mPEG C4 diol as a white solid (6.7 g); ¹H NMR (400 MHz, CDCl₃) δ 3.91-3.86 (1H, m), 3.82 (2H, t, J=5.0 Hz), 3.47 (2H, t, J=5.2 Hz), 3.38 (3H, s), 2.74 (1H, t, J=5.8 Hz) and 1.77-1.70 (2H, m); ¹³C NMR (100 MHz, CDCl₃) δ 71.9, 68.8, 66.6, 59.0 and 32.8.

### EXAMPLE 6

### 5K mPEG propionaldehyde

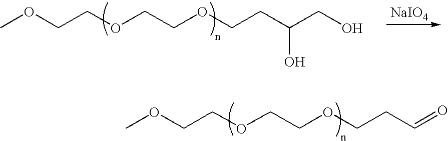

5K mPEG C4 diol (1.00 g, 0.2 mmol) was dissolved in water (5 mL), then sodium periodate (64 mg, 0.3 mmol) was added. The solution was stirred at room temperature for 1 h then most of the solvent was evaporated. Dichloromethane (5 mL) and magnesium sulfate were added, the solution was filtered and most of the solvent was evaporated to give mPEG propionaldehyde as a white solid (955 mg). ¹H NMR analysis indicated mPEG propionaldehyde to be present at about 85% of the total mPEG; ¹H NMR (400 MHz, CDCl₃) δ 9.79 (1H, t, J=3.6 Hz), 3.843.81 (4H, m), 3.50-3.46 (2H, m), 3.38 (3H, s) and 2.69 (2H, dd, J=6.4, 2.0 Hz); ¹³C NMR (100 MHz, CDCl₃) δ 201.2, 71.9, 64.9, 59.0 and 43.8.

The above reaction shows the novel mPEG propionaldehyde precursor of the invention in which the latent aldehyde functionality is present as a protected 1,2-diol, such as an acetonide or other acetal. The aldehyde functionality is unmasked according to the method of the invention by cleavage of the acetal or other 1,2-diol protective group followed by oxidative cleavage of the 1,2-diol with periodate. Both reaction steps can be carried out consecutively in a 1-pot procedure.

### EXAMPLE 7

### (S)-3-(2,2-Dimethyl-[1,3]dioxolan-4-yl)-ethan-1-yl 4-biphenylsulfonate

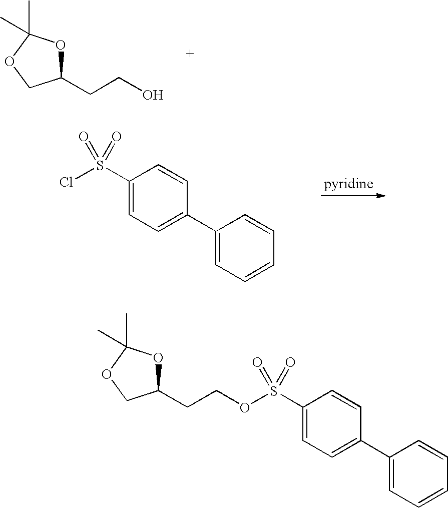

(S)-3-(2,2-Dimethyl-[1,3]dioxolan-4-yl)-ethan-1-ol, (12 g, 82 mmol) was dissolved in pyridine (60 mL). The solution was cooled to 0-5° C. 4-Biphenylsulfonyl chloride (24.9 g, 98 mmol) was added over 30 minutes. An exothermic reaction occurred. The suspension was stirred for 3-4 hours, then quenched with water (12 mL). The solution was stirred for 30 min., then toluene (120 mL) and 5% citric acid (60 mL) were added. The pH was adjusted to 3.5 with 2M HCl (230 mL), then the layers were separated. The organic layer was washed with 5% citric acid (50 mL) and saturated sodium bicarbonate solution (50 mL). The organic layer was dried (MgSO₄), filtered, then the solvent was evaporated to give the crude 4-phenylbenzenesulfonate as a viscous yellow liquid (24.6 g). This was crystallized from methanol-triethylamine (99:1, 1000 mL) to give a white, granular solid (10.8 g, 36%). ¹H NMR (CDCl₃, 400 MHz) δ ppm 7.97 (2H, d, J=8.6 Hz), 7.75 (2H, d, J=8.6 Hz), 7.61 (2H, d, J=6.8 Hz), 7.52-7.41 (3H, m), 4.29-4.11 (3H, m), 4.00 (1H, dd, J=8.0, 6.0 Hz), 3.54 (1H, t, dd, J=8.0, 6.8 Hz), 2.00-1.86 (2H, m), 1.34 (3H, s) and 1.29 (3H, s). ¹³C NMR (CDCl₃, 100 MHz) δ ppm 147.2, 139.4, 134.8, 129.5, 129.2, 128.8, 128.3, 127.8, 109.5, 72.6, 69.5, 68.1, 33.6, 27.3 and 25.9.

### EXAMPLE 8

### 20K MPEG C4 Acetonide

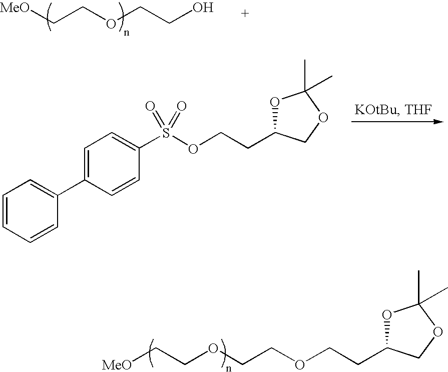

20K mPEG alcohol (100 g, 5 mmol) was placed in a dry flask, which was purged with nitrogen, and anhydrous THF (2 L) added. The suspension was heated to 40° C. and maintained at this temperature until a solution was generated. The reaction mixture was then cooled to 25° C. Potassium tert-butoxide (1.0 M in THF, 25 mL) was added. A solution of the C4 acetonide (S)-3-(2,2-Dimethyl-[1,3]dioxolan-4-yl)-ethan-1-yl 4-biphenylsulfonate (9.0 g, 25 mmol) in anhydrous THF (50 mL) was added over 10 minutes. The resulting suspension was stirred for 4 hours and then filtered through paper. MTBE (2 L) was added slowly to the filtrate to generate precipitation. The resulting solid was collected by filtration and washed with MTBE (200 mL), to afford a pink powder. This was dried overnight under vacuum at ambient temperature. The product was further purified by dissolving the pink powder in toluene (1 L) at 40° C. The resulting opaque solution was filter through Celite® to afford a clear yellow solution. The toluene solution of the product was then added dropwise to a rapidly stirred mixture of heptane/triethylamine (3.5 L /10 mL) to generate a final suspension, which was collected by filtration. The resultant white powder was dried overnight under vacuum at ambient to afford 20K MPEG C4 acetonide (89.5 g, 90%). ¹H NMR (400 MHz, CDCl₃) δ ppm 4.17 (1H, m), 4.08 (1H, m), 3.49 (3H,s), 1.92-1.84 (2H, m),1.50 (3H, s) and 1.46 (3H, s).

### EXAMPLE 9

### 20K mPEG Propionaldehyde

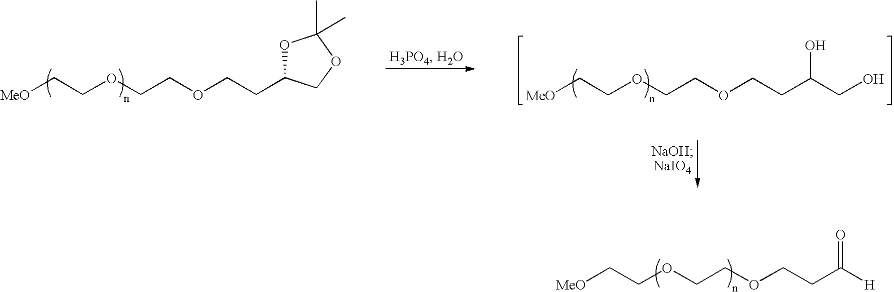

A 0.1 molar solution of ortho-phosphoric acid was prepared from ortho-phosphoric acid (13.1 g, 133 mmol) and water (1340 mL). 20K mPEG C4 acetonide (89 g, 4.5 mmol) was added to the acid solution and over approximately 1 hour a yellow solution formed. The solution was stirred for 15 hours, after which a sample was taken to check for the complete consumption of acetonide by ¹H NMR. Once the in-process check had been satisfied, the pH was increased to 5-6 with 2 molar sodium hydroxide.

Orion perchlorate electrode and silver/silver chloride reference electrodes were then added to the reaction mixture, and a conductivity reading of 211 Ω⁻¹m⁻² taken. Sodium periodate (0.1 M, 45 mL) was added, and the conductivity reading dropped to 111 Ω⁻¹m⁻². After 10 minutes the reading had stabilised at 149 Ω⁻¹m⁻², and 1,2-propanediol (0.1M, 45 mL) was added. After approximately 3 minutes the conductivity reading had returned to 211 demonstrating that the quench was complete. The reaction mixture was then extracted with dichloromethane (10×200 mL) and the dichloromethane evaporated to afford an off white residue. The product was dissolved in dichloromethane (200 mL) and then added dropwise to MTBE (2.5 L). The resultant precipitate was collected by filtration and dried overnight under vacuum at ambient to give 20K mPEG propionaldehyde as a white solid (78.2 g, 88%). ¹H NMR (400 MHz, CDCl₃) δ ppm 9.78 (1H, s), 3.35 (3H, s), 2.7 (2H, td, J=6.8, 1.6 Hz). ¹³C NMR (100 MHz, CDCl₃) δ ppm 201.2 (CHO), 71.9 (CH₂OCH₃), 70 (CH₂CH₂)O, 64.8 (CH₂CH₂CHO), 59.0 (CH₃) and 43.8 (CH₂CH₂CHO).

### EXAMPLE 10

### 30K mPEG C4 Acetonide

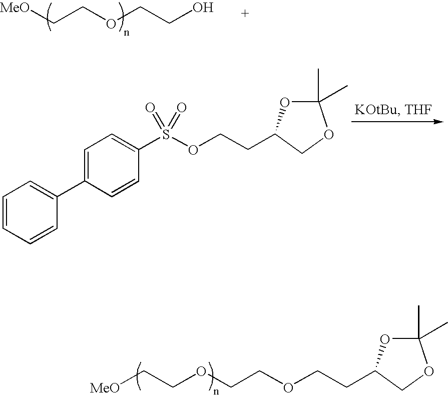

30K-mPEG alcohol (10 g, 0.33 mmol) was placed in a dry flask, which was purged with nitrogen, and anhydrous THF (200 mL) added. The suspension was heated to 40° C. and maintained at this temperature until a solution was generated. The reaction mixture was then cooled to 25° C. Potassium tert-butoxide (1.0 M in THF, 2.5 mL) was added. A solution of the C4 acetonide (S)-3-(2,2-Dimethyl-[1,3]dioxolan-4-yl)-ethan-1-yl 4-biphenylsulfonate (0.9 g, 25 mmol) in anhydrous THF (5 mL) was added over 10 minutes. The resulting suspension was stirred for 3 hours and then filtered through Celite®. MTBE (200 mL) was added slowly to the filtrate to generate precipitation. The resulting solid was collected by filtration and washed with MTBE (20 mL), to afford an off white powder. This was dried overnight under vacuum at ambient temperature. The product was further purified by dissolving in toluene (100 mL) at 40° C. The resulting opaque solution was filter through Celite® to afford a clear yellow solution. The toluene solution of the product was then added dropwise to a rapidly stirred mixture of heptane/triethylamine (350 mL /1 mL) to generate a final suspension, which was collected by filtration. The resultant white powder was dried overnight under vacuum at ambient to afford 30K mPEG C4 acetonide (7.7 g, 77%). ¹H NMR (400 MHz, CDCl₃) δ ppm 4.17 (1H, m), 4.08 (1H, m), 3.29 (3H,s), 1.94-1.78 (2H, m), 1.40 (3H, s) and 1.35 (3H, s).

### EXAMPLE 11

### 30K mPEG Propionaldehyde

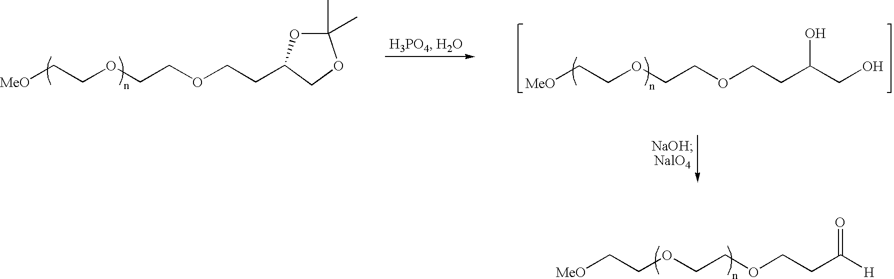

A 0.1 molar solution of ortho-phosphoric acid was prepared from ortho-phosphoric acid (0.75 g, 7.6 mmol) and water (77 mL). 30K mPEG C4 acetonide (7.6 g, 0.25 mmol) was added to the acid solution and over approximately 1 hour a yellow solution formed. The solution was stirred for 15 hours, after which a sample was taken to check for the complete consumption of acetonide by ¹H NMR. Once the in-process check had been satisfied, the pH was increased to 5-6 with 2 molar sodium hydroxide.

Orion perchlorate electrode and silver/silver chloride reference electrodes were then added to the reaction mixture, and a conductivity reading of 223 Ω⁻¹m⁻² taken. Sodium periodate (0.1 M, 2.5 mL) was added, and the conductivity reading dropped to 112 Ω⁻¹m⁻². After 10 minutes the reading had stabilised at 156 Ω⁻¹m⁻², and 1,2-propanediol (0.1 M, 2.5 mL) was added. After approximately 3 minutes the conductivity reading had returned to 223 demonstrating that the quench was complete. The reaction mixture was then extracted with dichloromethane (10×20 mL) and the dichloromethane concentrated until ˜20 ml of viscous liquid remained. This concentrate was then added dropwise to MTBE (250 mL). The resultant precipitate was collected by filtration and dried overnight under vacuum at ambient to give 30K mPEG propionaldehyde as a white solid (6.2 g, 82%). ¹H NMR (400 MHz, CDCl₃) δ ppm 9.78 (1H, s), 3.39 (3H, s), 2.70 (2H, dt, J=6.8, 1.6.Hz).

As can be seen from the above example, the main advantages of the method of the invention are the exceptionally mild conditions and ease of carrying out of the diol cleavage reaction. Since the mPEG propionaldehyde is unstable in the presence of acid or base, it is advantageous that the diol cleavage can be carried out at 20° C., pH 7.

What is claimed is:

1. A linear or branched polymer derivative comprising a water soluble and non-peptidic polymer backbone that incorporates an optionally protected vicinal diol, which is either embedded in the polymer backbone or is attached as a pendant group, wherein each linking group (linker) between the polymer backbone and the vicinal diol is a chain comprising at least two adjacent saturated carbon atoms.

2. A polymer according to claim 1, having the partial structure according to formula (1), wherein: R¹ and R² are independently H or a hydroxyl-protecting group or may be linked together to form a cyclic diol-protecting group; R³ and R⁴ are independently H or a hydrocarbon group or a second polymeric chain or may be linked to form a cyclic hydrocarbon; Polymer is a linear or branched polymer or a block or random copolymer; L represents a Linker between Polymer and the vicinal diol moiety in (1) and comprises a chain of at least two adjacent saturated carbon atoms.

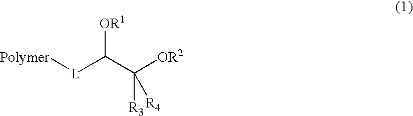

3. A polymer according to claim 2, having the structure according to formula (2) 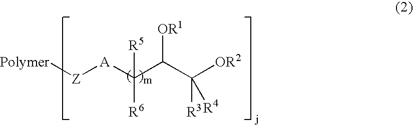
wherein Polymer is selected from the group consisting of poly(ethylene glycol), poly(vinyl alcohol), poly(alkylene oxides), poly(oxyethylated polyols), poly(olefinic alcohols), poly(acryloyl morpholine), poly(vinyl pyrrolidine), poly(oxazoline), dextran, poly(hydroxyethyl methacrylate) and derivatives thereof; Z is a hydrolysable or non-hydrolysable linker; A represents O, S, SO, SO₂, N, or NR⁷ wherein R⁷ is H, a hydrocarbon, a protecting group or a capping group; R⁵ and R⁶ are independently H or alkyl and on different C atoms within the group (CR⁵R⁶)n may either be the same or different; m is at least 2; j is in the range of 1-4.

4. A polymer derivative according to claim 3 wherein R¹ and R² are both H.

5. A polymer derivative according to claim 3 wherein R¹ and R² are combined to form a cyclic ketal or cyclic acetal.

6. A polymer derivative according to claim 5 wherein the combined residue R¹/R² is selected from the group consisting of isopropylidene, diethylmethylene, cyclopentylidene, cyclohexylidene and benzylidene.

7. A polymer derivative according to claim 6 wherein the combined residue R¹/R² is isopropylidene.

8. A polymer derivative according to claim 3 wherein R³ and R⁴ are both H.

9. A polymer derivative according to claim 3 wherein either R³ and R⁴ are the same and are selected from a group consisting of methyl, ethyl and propyl or the group. CR³R⁴ is selected from cyclopentyl or cyclohexyl,

10. A polymer derivative according to claim 3 wherein R³ is H and R⁴ is a second polymeric chain, such that oxidative cleavage of the polymer derivative (2) produces two identical fragments.

11. A polymer derivative according to claim 3 wherein Z is selected from the group consisting of linear or branched hydrocarbon chains which may optionally contain one or more heteroatoms.

12. A polymer derivative according to claim 11 wherein Z is (CH₂)₂.

13. A polymer derivative according to claim 3 wherein A is oxygen.

14. A polymer derivative according to claim 3 wherein R⁵ and R⁶ are both H.

15. A polymer derivative according to claim 3 wherein m is 2.

16. A polymer derivative according to claim 3 wherein j is 1.

17. A polymer derivative according to claim 3 wherein Polymer is poly(ethylene glycol) or a derivative thereof.

18. A polymer derivative according to claim 17 wherein Polymer is methoxy poly(ethylene glycol).

19. A polymer derivative according to claim 18 wherein Polymer has a polydispersity of less than 1.1.

20. A polymer derivative according to claim 19 wherein Polymer has a defined molecular weight of at least 5K and up to around 60K.

21. A polymer derivative according to claim 20 wherein defined molecular weights may be selected from the list comprising 5K, 10K, 20K, 30K and 40K.

22. A method for use of a polymer derivative according to claim 1, which comprises oxidative cleavage to form an aldehyde and either a second aldehyde or a ketone.

23. A method according to claim 22, wherein oxidative cleavage is effected by treatment with a hypervalent iodine reagent.

24. A method according to claim 23, wherein the reagent is a periodate reagent.

25. A method according to claim 24, wherein the reagent is sodium periodate.

26. A method according to claim 22, wherein oxidative cleavage is carried out in an aqueous medium.

27. A method according to claim 22, wherein the vicinal diol is protected, and also comprises the prior step of deprotection.

28. A method according to claim 27, wherein the vicinal diol is protected as a cyclic ketal or cyclic acetal and deprotection comprises acid-catalysed hydrolysis.

29. A method according to claim 28, wherein deprotection and subsequent oxidative cleavage of the resultant vicinal diol are combined in a single vessel operation.

30. A method according to claim 27, wherein the vicinal diol is protected as a benzylidene or analogous cyclic acetal and deprotection comprises hydrogenolysis.
